(19) United States
(12) Patent Application Publication
(10) Pub. No.: US 2005/0010487 A1
(43) Pub. Date: Jan. 13, 2005

(54) Method of financing a sports stadium or entertainment center

(76) Inventors: Lou Weisbach, Highland Park, IL (US); Scott A. Heiman, Glencoe, IL (US); Jack D. Sommer, Las Vegas, NV (US); Richard J. Boxer, Milwaukee, WI (US)

Correspondence Address: REINHART BOERNER VAN DEUREN S.C.;ATTN: LINDA GABRIEL, DOCKET COORDINATOR, 1000 NORTH WATER STREET, SUITE 2100, MILWAUKEE, WI, 53202, US

(21) Appl. No.: 10/745,780

(22) Filed: Dec. 23, 2003

(51) Int. Cl. G06F 17/60

(52) U.S. Cl. 705/26

(57) ABSTRACT

A method for the financing of new or replacement sports stadiums for professional sports or entertainment centers or the like is disclosed which finances such sports stadiums or entertainment centers through the sale of the exclusive interest in some or all of the individual seats in the sports stadium or entertainment center for the life of the sports stadium or entertainment center. A large number of the better seats in the newly constructed or renovated sports stadium or entertainment center are sold to buyers for the long term, with the buyer of each seat agreeing to pay the equivalent of the current season ticket price for the seat each year for a predetermined period of time. The sale of the seats and the resulting thirty-year contractual obligations to make payments are used to obtain a loan based upon the value of the payments over the thirty-year period, with the funds from this loan being used to pay for the newly constructed or renovated sports stadium or entertainment center.

### BACKGROUND OF THE INVENTION

### FIELD OF THE INVENTION

The present invention relates generally to the financing of new or replacement sports stadiums for professional or amateur sports or entertainment centers or the like, and more particularly to an improved method of financing such stadiums through the sale of the exclusive interest in some or all of the individual seats in the sports stadium or entertainment center for the life of the sports stadium or entertainment center.

Americans have long had an almost insatiable appetite for professional and amateur sports. The earliest professional sport in America was baseball, which began in the nineteenth century. Both hockey and soccer existed in the early nineteenth century, but neither became a professional sport until the twentieth century. Football, basketball, and hockey all began in the twentieth century and enjoy tremendous popularity today. All of these sports are played both professionally and on an amateur level, with large crowds in attendance. While occasionally professional sports teams were known to move from one city to another, up until the relatively recent past there was, for the most part, stability in professional sports franchises. Driven largely by television revenues, the profitability of professional sports teams experienced a rapid increase in the last two decades of the twentieth century, driving the salaries of professional players, the value of franchises, and a transition from the game aspects of professional sports to the business aspects of professional sports. A similar although less pronounced change has occurred in amateur sports on the major college level.

Both the value of a professional sports franchise and its profitability are closely tied to the stadium or entertainment center in which a team plays, with modern stadiums and entertainment centers with their luxury boxes and other amenities providing an almost staggering increase to the profitability of virtually any professional sports franchise. As a result, the era of simple agreements between team owners and stadium or entertainment center owners (the latter of which are frequently municipalities) has passed, leaving in its stead team owners who are willing to move if necessary to have a modern stadium or entertainment center in which to play. As a result, from the 1990's to the present, many municipalities have had to build new stadiums or entertainment center or perform major renovations on old stadiums or entertainment center in order to retain professional sports teams.

The complexity of funding the building or renovation of a sports stadium or an entertainment center has also increased significantly, with public funding having become an increasingly controversial issue due to the huge costs involved and the speculative nature of the return to the public on the investment. The conventional method of financing a publicly owned sports stadium or entertainment center has been for a public entity such as a city or county to issue bonds to generate the financing to build a new sports stadium or entertainment center or extensively renovate an old sports stadium or entertainment center. The source of revenue for the government body to repay the bonds is the revenue from tickets and concessions.

Season tickets are sold (for example, average baseball season tickets may cost forty dollars per game, times 81 games per season, or $3,240.00) for sporting events in the stadium or entertainment center, as are individual tickets. The principal benefit a fan gets from the purchase of season tickets is the right to attend all of the games that year while sitting in a particular seat. At the end of the year, the season ticket owner ends up with nothing more than the right to buy season tickets (generally for the same seat(s)) again the next year. Even that right has been subjected to a diminution of late in the form of “seat licenses,” an additional charge which only provides the fan with the right to buy season tickets for a fixed period of time ranging from one year to a longer period such as five years.

Historically, the revenue from tickets and from concessions has generally been paid to the governmental entity, which owns the stadium or entertainment center. Even though governmental entities own most professional sports stadiums and many entertainment centers, the professional sports teams playing in the stadiums or entertainment centers are getting most or all of the revenues from the stadium or entertainment center more and more frequently—from ticket sales to concession sales to parking revenues and stadium or entertainment center naming rights. This lucrative position is generally obtained by the threat (either implicit or explicit) to abandon the city or county for another geographic location, and there has been no shortage of cities or counties seeking to obtain one of the limited number of professional sports franchises available.

However, as the cost to build state-of-the-art professional and college sports stadiums and entertainment center has risen, many times local or state governments have been forced to go to the voters for approval to borrow the massive amounts of money and to sell governmental bonds to obtain the money needed to construct these sports stadiums or entertainment center. The argument that is typically used is that the presence of the professional sports team will provide an economic inflow of capital into the city or county which will more than offset the tremendous cost of building the sports stadium or entertainment center. The one certainty when public money is to be used for the construction of a new sports stadium or entertainment center is that it will take a significant period of time to line up the financing before initial construction can begin, thereby potentially resulting in the loss of an opportunity to have a professional sports franchise from moving to or being placed in a particular city or county.

It is accordingly the primary objective of the method of financing the construction of sports stadiums or entertainment centers of the present invention that it provide an improved method of financing the construction or renovation of a stadium for professional or college sports or an entertainment center. It is a related objective of the present invention that the method of raising funds employed by the present invention not require the ratification of the public in the form of a referendum or other ballot initiative. It is another related objective of the present invention that the funds raised by using the method of the present invention be raised privately without necessitating the incidence of any public indebtedness or requiring the issuance of bonds. It is another primary objective of the present invention that the method of raising funds utilized by the present invention be susceptible of raising sufficient funds to allow a state-of-the-art stadium or entertainment center to be built.

It is yet another objective of the method of financing the construction of sports stadiums or entertainment centers of the present invention that it provide an ownership position to investors in exchange for their long-term commitment to buy seats located in the sports stadium or entertainment center. It is a closely related objective of the method of the present invention that the seats in the stadium or entertainment center being financed have attributes akin to those of real property in that they can be sold or inherited. It is still another objective of the method of raising funds utilized by the present invention that it provide the investors with the aforementioned ownership interest at a price which is essentially identical to the cost of purchasing season tickets for the same seats. It is yet another objective of the method of the present invention that it provide a readily ascertainable indication of both present and future cost of the seats in the stadium or entertainment center to the investors, thereby removing the threat of unforeseeable future seat license costs or other similar charges.

The method of financing the construction of sports stadiums or entertainment centers of the present invention must also be both fully legal and unlikely to engender litigation, and it should also require little or no effort to be provided by the investors providing the funding for its operation. In order to enhance the market appeal of the method of the present invention, it should be substantially attractive to buyers from a financial standpoint to thereby afford it the broadest possible market. Finally, it is also an objective that all of the aforesaid advantages and objectives of the method of financing the construction of sports stadiums or entertainment centers of the present invention be achieved without incurring any substantial relative disadvantage.

### SUMMARY OF THE INVENTION

The disadvantages and limitations of the background art discussed above are overcome by the present invention. With this invention, instead of merely buying season tickets, a ticket holder would instead enter into a novel agreement for an ownership interest in one or more seats in a stadium or entertainment center (which may include concert halls and theaters as well) to be newly built or substantially renovated. The agreement has characteristics of an installment loan agreement, a condominium ownership agreement, and a mortgage.

In the agreement, a seat buyer agrees to pay periodic (typically annual) installments of money for a predetermined number of years, typically from twenty to forty years. In exchange for making the annual payments in each year, the seat buyer receives the right to be admitted to the sports stadium or entertainment center and to occupy one or more particular seats in the sports stadium or entertainment center for the events occurring in the stadium or entertainment center during that year, an ownership interest which is similar to the ownership interest in a condominium. The collateral used to secure the loan is the quasi-ownership right in the seat or seats.

The payments for the loan are established at the outset so that the seat buyer will pay the same amount for each annual payment as the cost for a season ticket for the particular seat the seat buyer is acquiring the right in. The annual payment by the seat buyer will be attributed to the interest and the principle reduction payments made on a loan principle which is borrowed to finance the construction of the stadium or entertainment center. Thus, the entity operating the newly built or renovated sports stadium or entertainment center will receive the funds of the loan at the outset, and these funds will be used to build or renovate the sports stadium or entertainment center.

Each seat buyer would sign the agreement obligating him or her to pay the principle and interest payment each year. In the preferred embodiment, the agreement could have a thirty-year amortization with either thirty or forty years of payments. The combined revenues from a large number of similar agreements for seats in the new or renovated sports stadium or entertainment center will be sufficient to finance the construction of the sports stadium or entertainment center. The seats sold using the type of agreement contemplated by the present invention would typically be the best seats in the sports stadium or entertainment center.

For example, consider the seats in a baseball stadium at which there are eighty-one games each season. An average price for the more desirable seats in the baseball stadium may be approximately forty dollars at the present time. Thus, a season ticket for a single season at forty dollars per game times eighty-one games per year would cost $3,240.00. A thirty-year loan made at present interest rates with a $3,240.00 annual payment can generate a loan principle amount of $45,000.00. Accordingly, the sale of 20,000 seats would generate a loan of $900 million at the present time, which is more than sufficient to construct a state-of-the-art sports stadium or entertainment center.

In this preferred embodiment, the owner of the seat would own the seat, free and clear, after making thirty years of payments. The seat can be sold by the owner or inherited, just as real property can be. In the event of a sale of the seat, the seat owner may optionally be required to share a percentage of any profit with, or pay a transfer fee to, the stadium or entertainment center operator. The seat could also be sold or inherited prior to completion of the payments, but it would of course remain subject to the payment of the remainder of payments.

In the case of seats sold at a college sports stadium, some of the seat owners may at some point wish to donate the seats back to the college or university for a tax deduction based on the value of the seat, thereby helping fund construction of the stadium and also providing a later gift for the college or university. Thus, it may be seen that the method of financing the construction of sports stadiums or entertainment centers of the present invention is advantageous both to a stadium or entertainment center operator in its ability to generate private funds for the construction or renovation of a sports stadium or entertainment center and to the seat owner who may acquire a transferable interest in a seat at a long term price which is advantageous.

An optional enhancement of the present invention may be used to reflect the fact that sporting event ticket prices increase with inflation over time. Over the length of an agreement as long as that contemplated by the present invention (twenty to forty years), it will be appreciated that ticket prices will increase substantially. For example, over a thirty-year period, it is likely that ticket prices will nearly double.

Thus, an annual payment that is fixed at the cost of a season ticket for the first year will likely be just over half the price of a season ticket in the thirtieth year. As such, an optional seat price differential payment may be used as an embellishment to the preferred embodiment of the present invention. A seat price differential payment would not be present in the first year of the agreement, but would be included in the annual payment amount due in subsequent years to equalize the price paid to the price of a season ticket. Thus, if the price of a seat went from forty dollars to forty-two dollars per game, the seat buyer would have to pay the differential amount of two dollars times eighty-one games, or a total of an additional one hundred sixty-two dollars, in addition to the annual amount due for the purchase of the seat.

With this optional seat price differential payment, at the end of the payments, the owner of the seat would still own the seat outright, subject only to an annual payment of the differential amount. Thus, after completing the thirty years of payments (in the thirty year payment plan), if the price of the seat was originally forty dollars, the season ticket owner would pay only the differential amount, which is only approximately half of the value of the seat. In addition, the seat could be sold or inherited, just as real property can be.

It may therefore be seen that the present invention teaches an improved method of financing the construction or renovation of a stadium for professional or college sports or an entertainment center. The method of raising funds employed by the present invention does not require the ratification of the public in the form of a referendum or other ballot initiative. The funds raised by using the method of the present invention are raised privately without necessitating the incidence of any public indebtedness or requiring the issuance of bonds. The method of raising funds utilized by the present invention is susceptible of raising sufficient funds to allow a state-of-the-art stadium or entertainment center to be built.

The method of financing the construction of sports stadiums or entertainment centers of the present invention provides an ownership position to investors in exchange for their long-term commitment to buy seats located in the sports stadium or entertainment center. The seats in the stadium or entertainment center being financed have attributes akin to those of real property in that they can be sold or inherited. The method of raising funds utilized by the present invention provides the investors with the aforementioned ownership interest at a price which is essentially identical to the cost of purchasing season tickets for the same seats. The method of the present invention provides a readily ascertainable indication of both present and future cost of the seats in the stadium or entertainment center to the investors, thereby removing the threat of unforeseeable future seat license costs or other similar charges.

The method of financing the construction of sports stadiums or entertainment center of the present invention is both fully legal and unlikely to engender litigation, and it requires little or no effort to be provided by the investors providing the funding for its operation. The method of the present invention is substantially attractive to buyers from a financial standpoint to thereby enhance its market appeal and afford it the broadest possible market. Finally, all of the aforesaid advantages and objectives of the method of financing the construction of sports stadiums or entertainment centers of the present invention are achieved without incurring any substantial relative disadvantage.

### DESCRIPTION OF THE DRAWINGS

These and other advantages of the present invention are best understood with reference to the drawings, in which:

FIG. 1 is a flow diagram showing the fundamental operation of the method of financing the construction of sports stadiums or entertainment centers of the present invention through obtaining a loan based upon the sale of seats in a sports stadium or entertainment center;

FIG. 2 is a flow diagram showing the subsequent seat ticket operation of a sports stadium or entertainment center built using the method described in FIG. 1;

FIG. 3 is a chart showing certain financial ramifications of the operation of a sports stadium or entertainment center in which conventional season tickets are sold; and

FIG. 4 is a chart similar to the chart shown in FIG. 3, but showing the financial ramifications of the operations of a sports stadium or entertainment center the construction of which is financed by the method of the present invention.

### DETAILED DESCRIPTION OF THE PREFERRED EMBODIMENT

The preferred embodiment of the sports stadium or entertainment center construction financing method of the present invention has its basis in three central principles. First, a large number of the better seats in the newly constructed or renovated sports stadium or entertainment center are sold to buyers for the long term, with the right being sold being akin to the ownership interest in a condominium, namely a nonexclusive right to be admitted to the premises of the sports stadium or entertainment center for games and an exclusive right to occupy a particular seat during those games, not just for a single season but for the entire life of the sports stadium or entertainment center.

Second, the buyer of each seat agrees to pay the equivalent of the current season ticket price for the seat each year for a predetermined period of time, typically for a period of twenty to forty years. In the preferred embodiment of the sports stadium or entertainment center construction financing method, the agreement would have a thirty-year amortization with either thirty of forty years of payments. Thus, for example, the buyer of each seat is agreeing to become contractually obligated to pay the current season ticket price each year for a thirty-year period. These payments may be made either annually (which is preferred) or more frequently (e.g., semi-annually, quarterly, or monthly), and can be made either directly to the lender or to an operator of the sports stadium or entertainment center, who will then pay the lender.

Third, the sale of the better seats in the newly constructed or renovated sports stadium or entertainment center and the resulting thirty-year contractual obligations to make payments are used as a vehicle to obtain a loan based upon the value of the payments over the thirty-year period. The funds from this loan will be used to pay for the construction of the new or renovated sports stadium or entertainment center, with the annual payments from the buyers of the seats being paid to the lender to repay the loan.

In an optional embellishment to the sports stadium or entertainment center construction financing method of the present invention, a fourth principle may be added to the first three. Under this optional fourth principle, the buyer of each seat would also agree to pay a differential payment in years after the first year. This differential payment is the difference between the current season ticket value for the seat and the annual payment or first year season ticket value for the seat. The funds received from the differential payment may be used to fund the operation of the sports stadium or entertainment center and/or the team occupying the sports stadium or entertainment center. Alternately, they may be set aside to pay for future renovations of the sports stadium or entertainment center.

By way of example, seats for major league baseball currently range in price from six dollars to nearly three hundred dollars per seat, per game, and in most baseball stadiums there are approximately twenty thousand tickets better seats which have an average price of approximately forty dollars per seat, per game. At this average price of forty dollars per seat, per game, a season ticket (there are eighty-one home games per season in major league baseball) for such an average one of the better seats would cost $3,240.00. An agreement to pay this value per year for a thirty-year period would secure a $44,600.00 loan at current interest rates. If all twenty thousand of the better seats are sold, it will thus be appreciated that the loans for these seats would result in $892 million in funds available to build or renovate a state-of-the-art sports stadium or entertainment center.

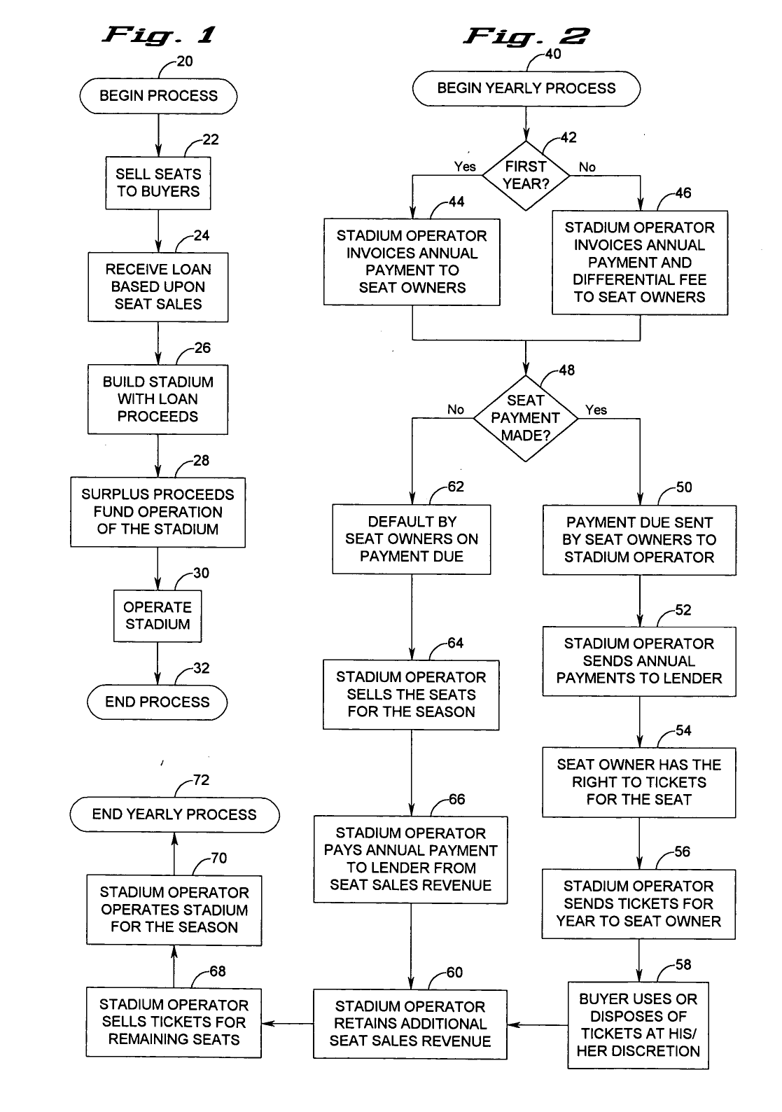

Turning now to FIG. 1, the sports stadium or entertainment center construction financing method of the present invention is illustrated in its simplest form. The sports stadium or entertainment center construction financing method begins with a process initiation step 20, and moves to a seat sale step 22 in which the better seats in the sports stadium or entertainment center to be built or renovated are sold to buyers. These seats are the better quality (i.e., prime location and higher price) seats in the sports stadium or entertainment center. The buyers of these seats would sign agreements obligating them to make payments for the seats for an extended period of time (thirty years in the example used herein), and these agreements would be used to secure a loan in a seat sales-based loan step 24.

The funds from the loan are then used to construct a new sports stadium or entertainment center or to renovate an old sports stadium or entertainment center in a stadium building step 26. The operation of the sports stadium or entertainment center (and, potentially, the team playing there) is funded by all receipts other than the seat payments made by the buyers of the seats, as shown in a surplus proceeds use step 28. This would include proceeds from the sale of season tickets (as opposed to tickets for seats purchased), proceeds from the sale individual tickets, concession revenue, parking revenue, and stadium or entertainment center naming rights.

According to the optional embellishment to the present invention, in years subsequent to the first season after which the seats are sold to seat buyers, proceeds would also include additional seat price differential fees levies on seat buyers. The seat price differential fee for each seat sold reflects the difference between the season ticket value of that seat less the annual payment amount due for the purchase of the seat. This reflects the normal inflation-based year-to-year increase in the price of season tickets. For example, if the per-game price for a particular seat went from forty dollars to forty-two dollars, the seat price differential fee for the year would be an additional one hundred sixty-two dollars (two dollars per game times eighty-one games per season).

Thus, this revenue is also available for operation of the sports stadium or entertainment center and/or the professional team associated with it. With the surplus revenue, the sports stadium or entertainment center owner will operate the sports stadium or entertainment center, as shown in a stadium operation step 30. The basic process of the present invention then terminates in a process completion step 32.

It will be appreciated that the owner of a seat may sell the seat at any time, either before or after completion of the annual payments for the seat. Of course, any sale of a seat prior to completing the annual payments will require either an early payoff of the amount due or the assumption of obligation to complete the payments by the new owner. Thus, the seat buyer is able to resell the seat, potentially at a significant profit. The agreement may optionally require a sharing of either the profit on a seat sale or the sales price of the seat with the stadium or entertainment center operator (the percentage could either be fixed or it may vary over time), or it may impose a mandatory transfer fee (this transfer fee could either be fixed or it may very over time).

Referring next to FIG. 2, the annual process of operating the sports stadium or entertainment center is shown in greater detail, beginning with an annual process initiation step 40. If the optional embellishment of a seat price differential fee is to be used, the process differs depending on whether or not the present year is the first season following the sale of seats according to the principles of the present invention, as determined in a first year determination step 42. If the present year is the first season following the sale of seats (or every year if the optional seat price differential is not to be used), the process moves to an invoice annual payment step 44 in which the amount of the annual payment that is due for the sale of the seats is invoiced to seat buyers.

If, on the other hand, the present year is not the first season following the sale of seats and the seat price differential fee is being used, the process moves instead to an invoice annual payment and differential fee step 46. According to the invoice annual payment and differential fee step 46, the amount of the annual payment which is due for the sale of the seats plus the differential fee, which will increase each season as the value of the seats owned by seat buyers increases, with the annual payment for the purchase of the seats remaining fixed.

From the relevant one of the invoice annual payment step 44 and the invoice annual payment and differential fee step 46, the process next moves to a seat payment made determination step 48, wherein a determination is made as to whether or not the owner of each of the seats sold had made the requisite payment for their seat(s) for the year. If the payment due from the seat owner has been made as depicted in a seat owner payment step 50, the portion of the payment attributable to the annual payment due for the purchase of the seat(s) is sent to the lender as shown in a paid seat payment loan payment step 52.

As a result of the seat owner having paid for the seat(s) owned by him, her, or it, the seat owner is entitled to the season tickets for the seat(s) as indicated in a seat owner use right step 54. As such, the operator of the sports stadium or entertainment center will thus send the season tickets for the seat(s) to the seat owner in a send season tickets step 56. The seat owner can then use of dispose of the season tickets for the owner seat(s) at his, her, or its discretion, as shown in a seat owner ticket use step 58.

However, any revenue from the payments received from the seat owners which are from the optional differential payments and are therefore in excess of the annual payments due for the purchase of the seats are retained by the sports stadium or entertainment center operator and are available for the operation of the sports stadium or entertainment center, as indicated in a additional seat sales revenue step 60.

Returning for the moment to the seat payment made determination step 48, if, on the other hand, the payment due from the seat owner has not been made as depicted in a seat owner default step 62, the sports stadium or entertainment center operator is free to sell the tickets for those seat(s) for all games that season to recover the cost due from the seat owner, as indicated in an owner seat sales step 64. It will be appreciated that the right of the sports stadium or entertainment center operator to do so would be established in the seat sales agreement, and would be in the nature of a penalty. Other penalties could also be assessed, including either or both financial penalties and the ultimate forfeiture of the seat(s).

Assuming that the sports stadium or entertainment center operator is able to sell the seat(s) for the season, the revenue from that sale will go first to pay the annual amount due for the purchase of the seat, whereupon the sports stadium or entertainment center operator will send the annual payment due for the purchase of the seat(s) to the lender as shown in a the unpaid seat payment loan payment step 66. Any funds remaining from the sale of tickets that season for seats of defaulting seat owners which are in excess of the annual payments due for the purchase of the seats are retained by the sports stadium or entertainment center operator and are available for the operation of the sports stadium or entertainment center, as indicated in the additional seat sales revenue step 60.

All other seats in the sports stadium or entertainment center which have not been sold according to the principles of the present invention are available either for purchase as conventional season tickets, as part of multi-game packages, or on a game-by-game basis, as indicated in the remaining ticket sale step 68. Using both the additional revenue obtained in the additional seat sales revenue step 60 and the revenue obtained in the remaining ticket sale step 68, as well as other revenue from such sources as parking and concessions, enable the sports stadium or entertainment center operator to operate the sports stadium or entertainment center for the year, as indicated in the stadium operation step 70. The annual process terminates in the annual process completion step 72, and is repeated annually.

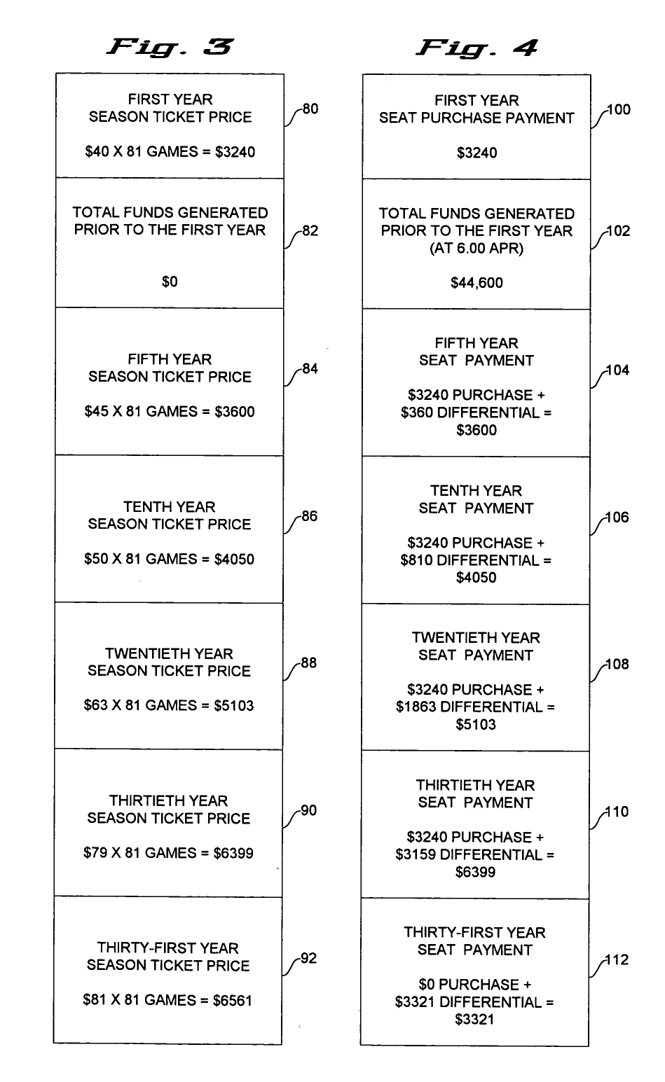

Turning now to FIG. 3, the financial ramifications of the conventional purchase of season tickets over an extended period of time are demonstrated using as an example a seat selling for forty dollars per game at the outset. The cost of season tickets for this seat is $3,240.00 (forty dollars per game times eighty-one games per season), as indicated in a first year season ticket cost cell 80. Since in the conventional situation no capitol funds are being generated, that fact is indicated in a pre-first year funds generated cell 82.

In the fifth year, the season ticket price for the seat has increased from forty dollars per game to forty-five dollars per game. The cost of season tickets for this seat is now $3,600.00 (forty-five dollars per game times eighty-one games per season), as indicated in a fifth year season ticket cost cell 84. In the tenth year, the season ticket price for the seat has increased to fifty dollars per game. The cost of season tickets for this seat is now $4,050.00 (fifty dollars per game times eighty-one games per season), as indicated in a tenth year season ticket cost cell 86.

In the twentieth year, the season ticket price for the seat has increased to sixty-three dollars per game. The cost of season tickets for this seat is now $5,103.00 (sixty-three dollars per game times eighty-one games per season), as indicated in a twentieth year season ticket cost cell 88. In the thirtieth year, the season ticket price for the seat has increased to seventy-nine dollars per game. The cost of season tickets for this seat is now $6,399.00 (seventy-nine dollars per game times eighty-one games per season), as indicated in a thirtieth year season ticket cost cell 90.

In the thirty-first year, the season ticket price for the seat has increased to eighty-one dollars per game. The cost of season tickets for this seat is now $6,561.00 (eighty-one dollars per game times eighty-one games per season), as indicated in a thirty-first year season ticket cost cell 92. It will be appreciated that the cost of the season ticket continues to increase, without the season ticket holder having any rights other than the right to buy a season ticket the next year for the same seat.

Moving finally to FIG. 4, the financial ramifications of the purchase of a seat under the principles of the sports stadium or entertainment center construction financing method of the present invention are demonstrated over an extended period of time, using as an example a seat which as a conventional season ticket would sell for forty dollars per game at the outset. This example assumes that the option seat price differential fee is utilized. The annual payment for the purchase of this seat is $3,240.00 (the same as it would cost as a season ticket), as indicated in a first year seat purchase cost cell 100. Since according to the teachings of the sports stadium or entertainment center construction financing method of the present invention capitol funds are being generated through a loan, that fact is indicated in a pre-first year funds generated cell 102. The amount of the loan that can be generated based upon thirty years of payments of $3,240.00 per year is $44,600.00 as present interest rates (six percent).

In the fifth year, the season ticket price for the seat has increased to $3,600.00, as shown in the fifth year season ticket cost cell 84 (FIG. 3). The annual payment due for the purchase of the seat remains at $3,240.00, with a differential fee of $360.00 ($3,600.00 for a season ticket minus $3,240.00) also being due, for a total cost of $3,600.00 as indicated in a fifth year seat purchase cost cell 104. In the tenth year, the season ticket price for the seat has increased to $4,050.00, as shown in the tenth year season ticket cost cell 86 (FIG. 3). The annual payment due for the purchase of the seat remains at $3.240.00, with a differential fee of $810.00 ($4,050.00 for a season ticket minus $3,240.00) also being due, for a total cost of $4,050.00 as indicated in a tenth year seat purchase cost cell 106.

In the twentieth year, the season ticket price for the seat has increased to $5.103.00, as shown in the twentieth year season ticket cost cell 88 (FIG. 3). The annual payment due for the purchase of the seat remains at $3,240.00, with a differential fee of $1,863.00 ($5,103.00 for a season ticket minus $3,240.00) also being due, for a total cost of $5,103.00 as indicated in a twentieth year seat purchase cost cell 108. In the thirtieth year, the season ticket price for the seat has increased to $6,399.00, as shown in the thirtieth year season ticket cost cell 90 (FIG. 3). The annual payment due for the purchase of the seat remains at $3,240.00, with a differential fee of $3,159.00 ($6,399.00 for a season ticket minus $3,240.00) also being due, for a total cost of $6,399.00 as indicated in a thirtieth year seat purchase cost cell 110.

In the thirty-first year, the season ticket price for the seat has increased to $6,561.00, as shown in the thirty-first year season ticket cost cell 92 (FIG. 3). The annual payments due for the purchase of the seat have been made in full, so only a differential fee of $3,321.00 ($6,561.00 for a season ticket minus $3,240.00) being due, for a total cost of $3,321.00 as indicated in a thirty-first year seat purchase cost cell 112. It will thus be appreciated that for the first thirty years even with the optional seat price differential fee the cost to a seat buyer is no higher than the cost of purchasing a comparable season ticket, with the benefit being ownership as opposed to a mere right to occupy and the right of first refusal for the same seat the next season. If the optional seat price differential fee is not used, the cost will remain the same for the entire thirty year period, representing an increased saving each year. After the seat purchase is fully paid off, the cost per season is substantially lower than the cost of purchasing a comparable season ticket if the optional seat price differential fee is used. If the optional seat price differential fee is not used, the seat would be free after the seat purchase is paid off.

The occupancy interest in the seats is contemplated as being sold for the life of the sports stadium or entertainment center, and may be resold or otherwise transferred by the seat owner at any time, subject to the required payments being made. However, it may be desirable in some circumstances to have it be of a predetermined number of years, but never than the number of years over which payments are to be made. For example, if payments are to be made over the thirty-year period as discussed herein, the ownership right may extend for a forty-year period. In any event, it will be appreciated that the benefits to seat owners are both real and substantial, and that the sports stadium or entertainment center construction financing method of the present invention enables the completely private financing of new sports stadiums or entertainment center.

It may therefore be appreciated from the above detailed description of the preferred embodiment of the present invention that it teaches an improved method of financing the construction or renovation of a stadium for professional or college sports or an entertainment center. The method of raising funds employed by the present invention does not require the ratification of the public in the form of a referendum or other ballot initiative. The funds raised by using the method of the present invention are raised privately without necessitating the incidence of any public indebtedness or requiring the issuance of bonds. The method of raising funds utilized by the present invention is susceptible of raising sufficient funds to allow a state-of-the-art stadium or entertainment center to be built.

The method of financing the construction of sports stadiums or entertainment centers of the present invention provides an ownership position to investors in exchange for their long-term commitment to buy seats located in the sports stadium or entertainment center. The seats in the stadium or entertainment center being financed have attributes akin to those of real property in that they can be sold or inherited. The method of raising funds utilized by the present invention provides the investors with the aforementioned ownership interest at a price which is essentially identical to the cost of purchasing season tickets for the same seats. The method of the present invention provides a readily ascertainable indication of both present and future cost of the seats in the stadium or entertainment center to the investors, thereby removing the threat of unforeseeable future seat license costs or other similar charges.

The method of financing the construction of sports stadiums or entertainment centers of the present invention is both fully legal and unlikely to engender litigation, and it requires little or no effort to be provided by the investors providing the funding for its operation. The method of the present invention is substantially attractive to buyers from a financial standpoint to thereby enhance its market appeal and afford it the broadest possible market. Finally, all of the aforesaid advantages and objectives of the method of financing the construction of sports stadiums or entertainment centers of the present invention are achieved without incurring any substantial relative disadvantage.

Although the foregoing description of the method of financing the construction of sports stadiums or entertainment centers of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

1. A method of financing the construction or renovation of a sports stadium for professional or amateur sports or an entertainment center or the like, said method comprising:
selling an occupancy interest in each of a plurality of seats in the sports stadium or entertainment center to a plurality of seat buyers in exchange for the agreement of each seat buyer to make a plurality of payments for a predetermined number of years;
obtaining loan funds of a principle amount from a lender which is to be repaid with interest by said payments from said seat buyers; and
using said loan funds of said principle amount for the construction or renovation of the sports stadium or entertainment center.

2. A method as defined in claim 1, wherein said plurality of seats in the sports stadium or entertainment center which are sold are less than all of the seats in the sports stadium or entertainment center.

3. A method as defined in claim 1, wherein said plurality of seats in the sports stadium or entertainment center which are sold are the better, more expensive seats in the sports stadium or entertainment center.

4. A method as defined in claim 1, wherein a sufficient number of the seats in the sports stadium or entertainment center are sold to generate adequate loan funds for the construction or renovation of the stadium or entertainment center.

5. A method as defined in claim 1, wherein said occupancy interest includes at least a right to be admitted to the sports stadium or entertainment center for events held at the sports stadium or entertainment center and the right to occupy a particular seat in the sports stadium or entertainment center for events held at the sports stadium or entertainment center.

6. A method as defined in claim 1, wherein the amount of said payments made each year is an amount which is approximately the same as the value of a season ticket for the purchased seat or a comparable seat at the time said agreement is entered into.

7. A method as defined in claim 1, wherein said payments remains constant during said predetermined number of years.

8. A method as defined in claim 1, wherein said payments are made annually.

9. A method as defined in claim 1, wherein said payments are made more frequently than annually.

10. A method as defined in claim 1, wherein said payments are paid by said seat buyers to an operator of the sports stadium or entertainment center, who in turn pays the payments to said lender.

11. A method as defined in claim 1, wherein said payments are paid by said seat buyers directly to said lender.

12. A method as defined in claim 1, wherein the amount of said loan funds is determined by the size and frequency of said payments, said predetermined number of years, and interest rates which prevail at the time said loan funds are obtained from said lender.

13. A method as defined in claim 1, additionally comprising:
obtaining the agreement of each seat buyer to additionally pay an differential fee each year that is approximately equal to the difference between the value of a season ticket for the purchased seat or a like seat and said payment.

14. A method as defined in claim 13, additionally comprising:
using said differential fees to fund the operation of said sports stadium or entertainment center and/or a sports team occupying said sports stadium or entertainment center.

15. A method as defined in claim 13, wherein said payments and said differential fees are paid together by said seat buyers to an operator of the sports stadium or entertainment center.

16. A method as defined in claim 13, wherein after said predetermined number of years, only said differential fees are due from said seat buyers.

17. A method as defined in claim 1, additionally comprising:
if any of said seat buyers default by not paying said payments when due each year, selling said seats of said defaulting seat buyers for the season to generate revenue to repay said lender.

18. A method as defined in claim 17, additionally comprising:
levying financial penalties against said defaulting seat buyers.

19. A method as defined in claim 1, wherein said predetermined number of years is between twenty and forty years.

20. A method as defined in claim 1, wherein said occupancy interest lasts for the life of the newly constructed or renovated sports stadium or entertainment center.

21. A method as defined in claim 1, wherein said occupancy interest lasts for a length of time which is longer than said predetermined number of years.

22. A method as defined in claim 1, wherein said seats may be resold by the respective seat buyers.

23. A method as defined in claim 22, wherein upon any sale of any seat(s) a payment must be made to an operator of the sports stadium or entertainment center.

24. A method as defined in claim 23, wherein said payment due upon the sale of any seat(s) is a transfer fee.

25. A method as defined in claim 24, wherein said transfer fee varies with time.

26. A method as defined in claim 23, wherein said payment due upon the sale of any seat(s) is a percentage of either the sale price or the profit made from the sale.

27. A method of financing the construction or renovation of a sports stadium for professional or amateur sports or an entertainment center or the like, said method comprising:
selling an occupancy interest in each of a plurality of, but less than all of, the seats in the newly constructed or renovated sports stadium or entertainment center to a plurality of seat buyers in exchange for the agreement of each seat buyer to make a plurality of annual payments for a predetermined number of years;
obtaining the agreement of each seat buyer to additionally pay an annual differential fee which is equal to the difference between the price of a season ticket for a like seat and said annual payment;
obtaining loan funds of a principle amount from a lender which is to be repaid with interest by said annual payments from said seat buyers;
using said loan funds of said principle amount for the construction or renovation of the sports stadium or entertainment center; and
using said differential fees to fund the operation of said sports stadium or entertainment center.

28. A method of financing the construction or renovation of a sports stadium for professional or amateur sports or an entertainment center or the like, said method comprising:
selling an occupancy interest in each of a plurality of seats in the new or replacement sports stadium or entertainment center to a plurality of seat buyers in exchange for the agreement of each seat buyer to make a plurality of periodic payments for a predetermined period of time;
obtaining a loan amount from a lender which loan amount will be repaid with interest by said periodic payments from said seat buyers; and
using said loan amount for the construction or renovation of the sports stadium or entertainment center.
